(19) United States
(12) Patent Application Publication
(10) Pub. No.: US 2025/0149633 A1
(43) Pub. Date: May 8, 2025

(54) ELECTROLYTE FOR RECHARGEABLE LITHIUM BATTERY AND RECHARGEABLE LITHIUM BATTERY INCLUDING THE SAME

(71) Applicant: SAMSUNG SDI CO., LTD., Yongin-si (KR)

(72) Inventors: Bomee KWON, Yongin-si (KR); Yeji YANG, Yongin-si (KR); JINAH SEO, Yongin-si (KR); Sujeong KOH, Yongin-si (KR); Erang CHO, Yongin-si (KR); SUNDAE KIM, Yongin-si (KR); Euisoo JEONG, Yongin-si (KR); JIN-HYEOK LIM, Yongin-si (KR); SANGHOON KIM, Yongin-si (KR)

(21) Appl. No.: 18/782,839

(22) Filed: Jul. 24, 2024

(30) Foreign Application Priority Data
Nov. 8, 2023 (KR) 10-2023-0153635

(51) Int. Cl. H01M 10/0567; H01M 4/02; H01M 4/525; H01M 10/052; H01M 10/0569

(52) U.S. Cl. CPC H01M 10/0567; H01M 4/525; H01M 10/052; H01M 10/0569; H01M 2004/028

(57) ABSTRACT

Disclosed are electrolytes for rechargeable lithium batteries and rechargeable lithium batteries including the same. The electrolyte includes a non-aqueous organic solvent, a lithium salt, a first additive that includes a borate-based lithium salt having a double bond between carbon atoms, and a second additive that includes a disultone-based compound.

### CROSS-REFERENCE TO RELATED APPLICATION

The present application claims priority to and the benefit of Korean Patent Application No. 10-2023-0153635, filed on Nov. 8, 2023, in the Korean Intellectual Property Office, the entire content of which is hereby incorporated by reference.

### BACKGROUND

### 1. Field

Embodiments of the present disclosure relate to an electrolyte for a rechargeable lithium battery and a rechargeable lithium battery including the same.

### 2. Description of the related art

Recently, with the rapid spread of battery using electronic devices, such as, for example, mobile phones, laptop computers, and electric vehicles, there is a rapidly increasing demand for rechargeable batteries having high energy density and high capacity. Therefore, intensive research has been conducted to improve performance of rechargeable lithium batteries.

A rechargeable lithium battery includes a positive electrode, a negative electrode, and an electrolyte, which positive and negative electrodes include an active material in which intercalation and deintercalation are possible, and generates electrical energy caused by oxidation and reduction reactions if lithium ions are intercalated and deintercalated.

A lithium salt dissolved in a non-aqueous organic solvent is used as the electrolyte for the rechargeable lithium battery. Characteristics of the rechargeable lithium battery are exhibited by complex reactions between the positive electrode and the electrolyte and between the negative electrode and the electrolyte. Accordingly, the use of a suitable or appropriate electrolyte is one of the variables for improvement of the rechargeable lithium battery.

### SUMMARY

An embodiment of the present disclosure provides an electrolyte for a rechargeable lithium battery that is capable of suppressing or reducing the generation of gas by reducing the oxidation decomposition and that has increased high-temperature lifetime and high-temperature retention properties.

An embodiment of the present disclosure provides a rechargeable lithium battery including the electrolyte mentioned above.

According to an embodiment of the present disclosure, an electrolyte for a rechargeable lithium battery may comprise: a non-aqueous organic solvent; a lithium salt; a first additive that includes a borate-based lithium salt having a double bond between carbon atoms; and a second additive that includes a disultone-based compound.

According to an embodiment of the present disclosure, a rechargeable lithium battery may comprise: a positive electrode that includes a positive electrode active material; a negative electrode that includes a negative electrode active material; and the electrolyte for the rechargeable lithium battery.

### BRIEF DESCRIPTION OF DRAWINGS

The accompanying drawings, together with the specification, illustrate embodiments of the subject matter of the present disclosure, and, together with the description, serve to explain principles of embodiments of the subject matter of the present disclosure.

FIG. 1 illustrates a simplified conceptual diagram showing a rechargeable lithium battery according to some embodiments of the present disclosure.

FIG. 2 is a simplified perspective view showing a rechargeable lithium battery according to some embodiments of the present disclosure.

FIG. 3 is a simplified cross-sectional view showing a rechargeable lithium battery according to some embodiments of the present disclosure.

FIGS. 4-5 are simplified perspective views showing rechargeable lithium batteries according to some embodiments of the present disclosure

### DETAILED DESCRIPTION

In order to sufficiently understand the configuration and effect of embodiments of the present disclosure, some embodiments of the present disclosure will be described with reference to the accompanying drawings. It should be noted, however, that the present disclosure are not limited to the following example embodiments, and may be implemented in various forms. Rather, the example embodiments are provided only to illustrate embodiments of the present disclosure and apprise those skilled in the art fully of the scope of the present disclosure.

In this description, it will be understood that, if an element is referred to as being on another element, the element can be directly on the other element or intervening elements may be present therebetween. In the drawings, thicknesses of some components may be exaggerated to effectively explain the technical contents of the present disclosure. Like reference numerals refer to like elements throughout the specification.

Unless otherwise specifically noted in this description, the expression of singular form may include the expression of plural form. In embodiments, unless otherwise specifically noted, the phrase “A or B” may indicate “A but not B”, “B but not A”, and “A and B”. The terms “comprises/includes” and/or “comprising/including” used in this description do not exclude the presence or addition of one or more other components.

In this description, the term “combination thereof” may refer to a mixing, a stack, a composite, a copolymer, an alloy, a blend, or a reaction product of the referenced components.

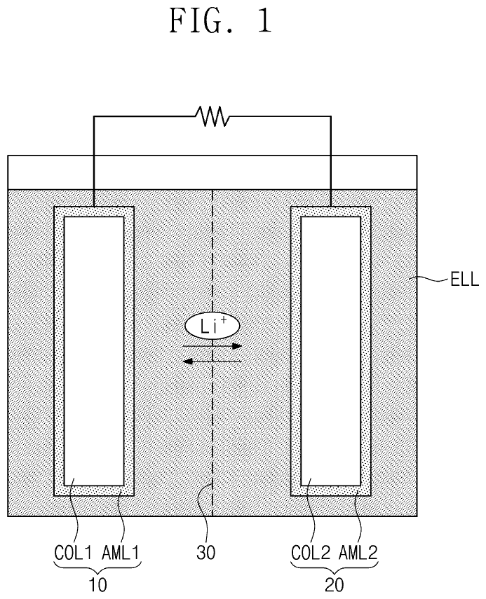

FIG. 1 illustrates a simplified conceptual diagram showing a rechargeable lithium battery according to some embodiments of the present disclosure. Referring to FIG. 1, a rechargeable lithium battery may include a positive electrode 10, a negative electrode 20, a separator 30, and an electrolyte ELL.

The positive electrode 10 and the negative electrode 20 may be spaced apart from each other across the separator 30. The separator 30 may be between the positive electrode 10 and the negative electrode 20. The positive electrode 10, the negative electrode 20, and the separator 30 may be in contact with the electrolyte ELL. The positive electrode 10, the negative electrode 20, and the separator 30 may be impregnated with the electrolyte ELL.

The electrolyte ELL may be a medium by which lithium ions are transferred between the positive electrode 10 and the negative electrode 20. In the electrolyte ELL, the lithium ions may move through the separator 30 toward one of the positive electrode 10 and the negative electrode 20.

### Positive Electrode 10

The positive electrode 10 for a rechargeable lithium battery may include a current collector COL1 and a positive electrode active material layer AML1 on the current collector COL1. The positive electrode active material layer AML1 may include a positive electrode active material and further include a binder and/or a conductive material (e.g., an electrically conductive material).

For example, the positive electrode 10 may further include an additive that can serve as a sacrificial positive electrode.

An amount of the positive electrode active material may be in a range from about 90 wt % to about 99.5 wt % based on 100 wt % of the positive electrode active material layer AML1. Amounts of the binder and the conductive material may be about 0.5 wt % and about 5 wt %, respectively, based on 100 wt % of the positive electrode active material layer AML1.

The binder may serve to improve attachment of positive electrode active material particles to each other and also to improve attachment of the positive electrode active material to the current collector COL1. The binder may include, for example, polyvinyl alcohol, carboxymethyl cellulose, hydroxypropyl cellulose, diacetyl cellulose, polyvinylchloride, carboxylated polyvinylchloride, polyvinylfluoride, ethylene oxide-containing polymer, polyvinylpyrrolidone, polyurethane, polytetrafluoroethylene, polyvinylidene fluoride, polyethylene, polypropylene, styrene-butadiene rubber, (meth)acrylated styrene-butadiene rubber, epoxy resin, (meth) acrylic resin, polyester resin, and/or nylon, but the present disclosure are not limited thereto.

The conductive material may be used to provide an electrode with conductivity (e.g., electrical conductivity), and any suitable conductive material (e.g., electrically conductive material) without causing chemical change of a battery (e.g., without causing an undesirable chemical change in the rechargeable lithium battery) may be used as the conductive material. The conductive material may include, for example, a carbon-based material such as natural graphite, artificial graphite, carbon black, acetylene black, Ketjen black, carbon fiber, carbon nano-fiber, and/or carbon nano-tube; a metal powder and/or metal fiber containing one or more of copper, nickel, aluminum, and silver; a conductive polymer (e.g., an electrically conductive polymer) such as a polyphenylene derivative; or a mixture thereof.

Al may be used as the current collector COL1, but the present disclosure is not limited thereto.

### Positive Electrode Active Material

The positive electrode active material in the positive electrode active material layer AML1 may include a compound (e.g., a lithiated intercalation compound) that is capable of reversible intercalation and de-intercalation of lithium. For example, the positive electrode active material may include at least one composite oxide of lithium and metal that is selected from cobalt, manganese, nickel, and a combination thereof.

The composite oxide may include a lithium transition metal composite oxide, for example, a lithium-nickel-based oxide, a lithium-cobalt-based oxide, a lithium-manganese-based oxide, a lithium-iron-phosphate-based compound, a cobalt-free nickel-manganese-based oxide, or a combination thereof.

For example, the positive electrode active material may include a compound expressed by one of chemical formulae below. LiₐA_{1-b}X_{b}O_{2-c}D_{c} (0.90≤a≤1.8, 0≤b≤0.5, 0≤c≤0.05), LiₐMn_{2-b}X_{b}O_{4-c}D_{c} (0.90≤a≤1.8, 0≤b≤0.5, 0≤c≤0.05), LiₐNi_{1-b-c}Co_{b}X_{c}O_{2-α}D_{α} (0.90≤a≤1.8, 0≤b≤0.5, 0≤c≤0.5, 0<α<2), LiₐNi_{1-b-c}Mn_{b}X_{c}O_{2-α}D_{α} (0.90≤a≤1.8, 0≤b≤0.5, 0≤c≤0.5, 0<α<2), LiₐNi_{b}Co_{c}L¹_{d}GₑO₂ (0.90≤a≤1.8, 0≤b≤0.9, 0≤c≤0.5, 0≤d≤0.5, 0≤e≤0.1), LiₐNiG_{b}O₂ (0.90≤a≤1.8, 0.001≤b≤0.1), LiₐCoG_{b}O₂ (0.90≤a≤1.8, 0.001≤b≤0.1), LiₐMn_{1-b}G_{b}O₂ (0.90≤a≤1.8, 0.001≤b≤0.1), LiₐMn₂G_{b}O₄ (0.90≤a≤1.8, 0.001≤b≤0.1), LiₐMn_{1-g}G_{g}PO₄ (0.90≤a≤1.8, 0≤g≤0.5), Li_{(3-f)}Fe₂(PO₄)₃ (0≤f≤2), and LiₐFePO₄ (0.90≤a≤1.8).

In the chemical formulae above, A is Ni, Co, Mn, or a combination thereof; X is Al, Ni, Co, Mn, Cr, Fe, Mg, Sr, V, a rare element, or a combination thereof; D is O, F, S, P, or a combination thereof; G is Al, Cr, Mn, Fe, Mg, La, Ce, Sr, V, or a combination thereof; and L¹ is Mn, Al, or a combination thereof.

For example, the positive electrode active material may be a high-nickel-based positive electrode active material having a nickel content of equal to or greater than about 80 mol %, equal to or greater than about 85 mol %, equal to or greater than about 90 mol %, equal to or greater than about 91 mol %, or equal to or greater than about 94 mol % and equal to or less than about 99 mol % based on 100 mol % of metal excluding lithium in the lithium transition metal composite oxide. The high-nickel-based positive electrode active material may achieve high capacity and thus may be applied to a high-capacity and high-density rechargeable lithium battery.

### Negative Electrode 20

The negative electrode 20 for a rechargeable lithium battery may include a current collector COL2 and a negative electrode active material layer AML2 on the current collector COL2. The negative electrode active material layer AML2 may include a negative electrode active material and may further include a binder and/or a conductive material (e.g., an electrically conductive material).

For example, the negative electrode active material layer AML2 may include a negative electrode active material of about 90 wt % to about 99 wt %, a binder of about 0.5 wt % to about 5 wt %, and a conductive material (e.g., an electrically conductive material) of about 0 wt % to about 5 wt %.

The binder may serve to improve attachment of negative electrode active material particles to each other and also to improve attachment of the positive electrode active material to the current collector COL2. The binder may include a non-aqueous binder, an aqueous binder, a dry binder, or a combination thereof.

The non-aqueous binder may include polyvinyl chloride, carboxylated polyvinyl chloride, polyvinyl fluoride, ethylene propylene copolymer, polystyrene, polyurethane, polytetrafluoroethylene, polyvinylidene fluoride, polyethylene, polypropylene, polyamide imide, polyimide, or a combination thereof.

The aqueous binder may include styrene-butadiene rubber, (meth)acrylated styrene-butadiene rubber, (meth)acrylic rubber, butyl rubber, fluoro rubber, polyethylene oxide, polyvinyl pyrrolidone, polyepichlorohydrin, polyphosphazene, poly(meth)acrylonitrile, ethylene propylene diene copolymer, polyvinyl pyridine, chlorosulfonated polyethylene, latex, polyester resin, (meth)acrylic resin, phenolic resin, epoxy resin, polyvinyl alcohol, or a combination thereof.

If an aqueous binder is used as the negative electrode binder, a cellulose-based compound capable of providing or increasing viscosity may further be included. The cellulose-based compound may include one or more of carboxymethyl cellulose, hydroxypropylmethyl cellulose, methyl cellulose, and alkali metal salts thereof. The alkaline metal may include Na, K, and/or Li.

The dry binder may include a fibrillizable polymer material, for example, polytetrafluoroethylene, polyvinylidene fluoride, polyvinylidene fluoride-hexafluoropropylene copolymer, polyethylene oxide, or a combination thereof.

The conductive material may be used to provide an electrode with conductivity (e.g., electrical conductivity), and any suitable conductive material (e.g., electrically conductive material) without causing chemical change of a battery (e.g., without causing an undesirable chemical change in the rechargeable lithium battery) may be used as the conductive material. For example, the conductive material may include a carbon-based material such as natural graphite, artificial graphite, carbon black, acetylene black, Ketjen black, carbon fiber, carbon nano-fiber, and carbon nano-tube; a metal powder and/or metal fiber including one or more of copper, nickel, aluminum, and silver; a conductive polymer (e.g., an electrically conductive polymer) such as a polyphenylene derivative; or a mixture thereof.

The current collector COL2 may include a copper foil, a nickel foil, a stainless steel foil, a titanium foil, a nickel foam, a copper foam, a polymer substrate coated with a conductive metal (e.g., an electrically conductive metal), or a combination thereof.

### Negative Electrode Active Material

The negative electrode active material in the negative electrode active material layer AML2 may include a material can reversibly intercalate and de-intercalate lithium ions, lithium metal, a lithium metal alloy, a material that can dope and de-dope lithium, and/or a transition metal oxide.

The material that can reversibly intercalate and de-intercalate lithium ions may include a carbon-based negative electrode active material, for example, crystalline carbon, amorphous carbon, or a combination thereof. For example, the crystalline carbon may include graphite such as non-shaped, sheet-shaped, flake-shaped, sphere-shaped, and/or fiber-shaped natural or artificial graphite, and the amorphous carbon may include soft carbon, hard carbon, mesophase pitch carbon, and/or calcined coke.

The lithium metal alloy may include an alloy of lithium and metal that is selected from Na, K, Rb, Cs, Fr, Be, Mg, Ca, Sr, Si, Sb, Pb, In, Zn, Ba, Ra, Ge, Al, and Sn.

The material that can dope and de-dope lithium may include a Si-based negative electrode active material and/or a Sn-based negative electrode active material. The Si-based negative electrode active material may include silicon, silicon-carbon composite, SiOₓ (0<x<2), Si—Q alloy (where Q is alkali metal, alkaline earth metal, element of Group 13, element of Group 14 (except for Si), element of Group 15, element of Group 16, transition metal, rare-earth element, or a combination thereof), or a combination thereof. The Sn-based negative electrode active material may include Sn, SnO₂, a Sn-based alloy, a combination thereof.

The silicon-carbon composite may be a composite of silicon and amorphous carbon. According to an embodiment, the silicon-carbon composite may be in the form of silicon particles and amorphous carbon coated on surfaces of the silicon particles.

For example, the silicon-carbon composite may include a secondary particle (core) in which primary silicon particles are assembled, and an amorphous carbon coating layer (shell) on a surface of the secondary particle. The amorphous carbon may also be between the primary silicon particles, and for example, the primary silicon particles may be coated with the amorphous carbon. The secondary particles may be dispersed in an amorphous carbon matrix.

The silicon-carbon composite may further include crystalline carbon. For example, the silicon-carbon composite may include a core including crystalline carbon and silicon particles and may also include an amorphous carbon coating layer on a surface of the core.

The Si-based negative electrode active material and/or the Sn-based negative electrode active material may be used in combination with a carbon-based negative electrode active material.

### Separator 30

Based on a type (or kind) of the rechargeable lithium battery, the separator 30 may be between the positive electrode 10 and the negative electrode 20. The separator 30 may include one or more selected from polyethylene, polypropylene, and polyvinylidene fluoride, and may have a multi-layered separator thereof such as a polyethylene/polypropylene bi-layered separator, a polyethylene/polypropylene/polyethylene tri-layered separator, and a polypropylene/polyethylene/polypropylene tri-layered separator.

The separator 30 may include a porous substrate and a coating layer on one or opposite surfaces of the porous substrate, which coating layer includes an organic material, an inorganic material, or a combination thereof.

The porous substrate may be a polymer layer including one selected from polyolefin such as polyethylene and/or polypropylene, polyester such as polyethylene terephthalate and/or polybutylene terephthalate, polyacetal, polyamide, polyimide, polycarbonate, polyetherketone, polyaryletherketone, polyetherimide, polyamideimide, polybenzimidazole, polyethersulfone, polyphenyleneoxide, cyclic olefin copolymer, polyphenylenesulphide, polyethylene naphthalate, glass fiber, Teflon, and/or polytetrafluoroethylene, and/or may be a copolymer and/or mixture including two or more of the materials mentioned above.

The organic material may include a polyvinylidenefluoride-based copolymer and/or a (meth)acrylic copolymer.

The inorganic material may include an inorganic particle selected from Al₂O₃, SiO₂, TiO₂, SnO₂, CeO₂, MgO, NiO, CaO, GaO, ZnO, ZrO₂, Y₂O₃, SrTiO₃, BaTiO₃, Mg(OH)₂, Boehmite, or a combination thereof, but the present disclosure are not limited thereto.

The organic material and the inorganic material may be present mixed in one coating layer or may be present as a stack of a coating layer including the organic material and a coating layer including an inorganic material.

### Electrolyte ELL

The electrolyte ELL for a rechargeable lithium battery may include a non-aqueous organic solvent, a lithium salt, a first additive, and a second additive.

The non-aqueous organic solvent may serve as a medium for that transmits ions that participate in an electrochemical reaction of a battery.

The non-aqueous organic solvent may include a carbonate-based solvent, an ester-based solvent, an ether-based solvent, a ketone-based solvent, an alcohol-based solvent, an aprotic solvent, or a combination thereof.

The carbonate-based solvent may include ethylene carbonate (EC), ethylmethyl carbonate (EMC), dimethyl carbonate (DMC), diethyl carbonate (DEC), dipropyl carbonate (DPC), methylpropyl carbonate (MPC), ethylpropyl carbonate (EPC), methylethyl carbonate (MEC), propylene carbonate (PC), and/or butylene carbonate (BC).

The ester-based solvent may include methyl acetate, ethyl acetate, n-propyl acetate, dimethyl acetate, methyl propionate, ethyl propionate, decanolide, mevalonolactone, valerolactone, and/or caprolactone.

The ether-based solvent may include dibutyl ether, tetraglyme, diglyme, dimethoxyethane, 2-methyltetrahydrofuran, 2.5-dimethyltetrahydrofuran, and/or tetrahydrofuran. The ketone-based solvent may include cyclohexanone. The alcohol-based solvent may include ethyl alcohol and/or isopropyl alcohol. The aprotic solvent may include nitriles such as R-CN (where R is a hydrocarbon group having a C2 to C20 linear, branched, or cyclic structure and may include a double bond, an aromatic ring, or an ether group); amides such as dimethylformamide; dioxolanes such as 1,3-dioxolane and/or 1,4-dioxolane; and/or sulfolanes.

The non-aqueous organic solvent may be used alone or in a mixture of two or more.

In embodiments, if a carbonate-based solvent is used, a cyclic carbonate and a chain carbonate may be mixed together and used, and the cyclic carbonate and the chain carbonate may be mixed together in a volume ratio of about 1:1 to about 1:9.

The lithium salt may be a material that is dissolved in the non-aqueous organic solvent to serve as a supply source of lithium ions in a battery and that plays a role in enabling a basic operation of a rechargeable lithium battery and in promoting the movement of lithium ions between positive and negative electrodes. The lithium salt may include, for example, at least one selected from LiPF₆, LiBF₄, LiSbF₆, LiAsF₆, LiClO₄, LiAlO₂, LiAlCl₄, LiPO₂F₂, LiCl, LiI, LiN(SO₃C₂F₅)₂, Li(FSO₂)₂N, lithium bis(fluorosulfonyl)imide (LiFSI), LiC₄F₉SO₃, LiN(CₓF₂ₓ+1SO₂)(C_{y}F_{2y}+1SO₂) (where x and y are integers of 1 to 20), lithium trifluoromethane sulfonate, lithium tetrafluoroethanesulfonate, lithium difluorobis(oxalato)phosphate (LiDFOB), and lithium bis(oxalato)borate (LiBOB)

### Rechargeable Lithium Battery

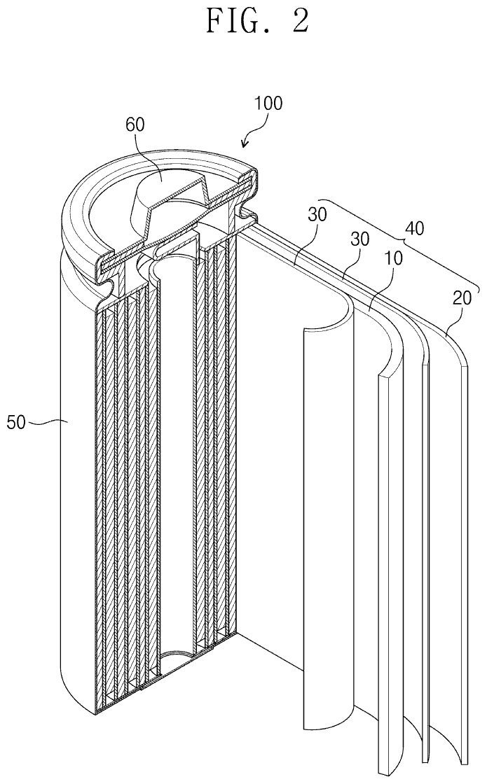

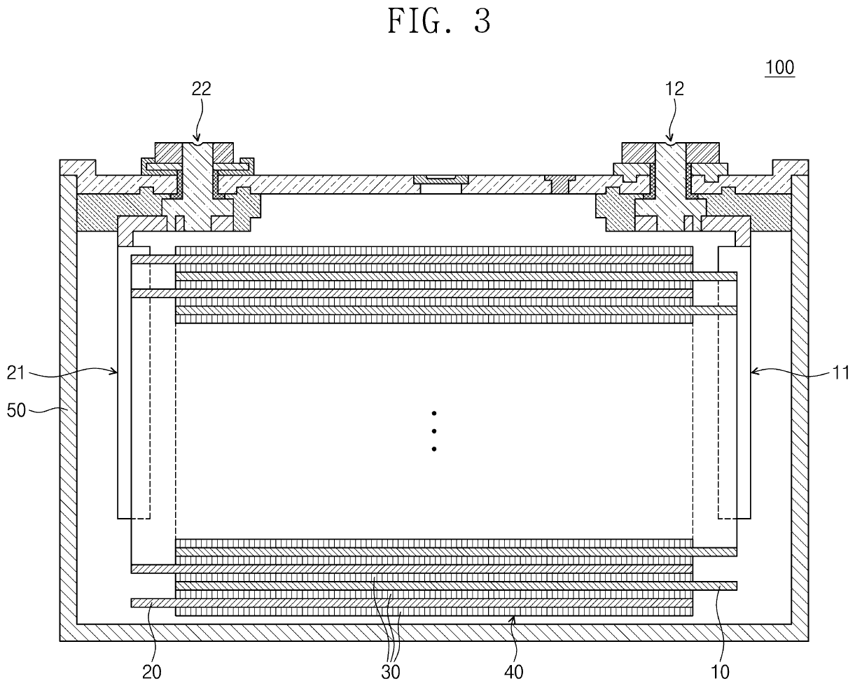

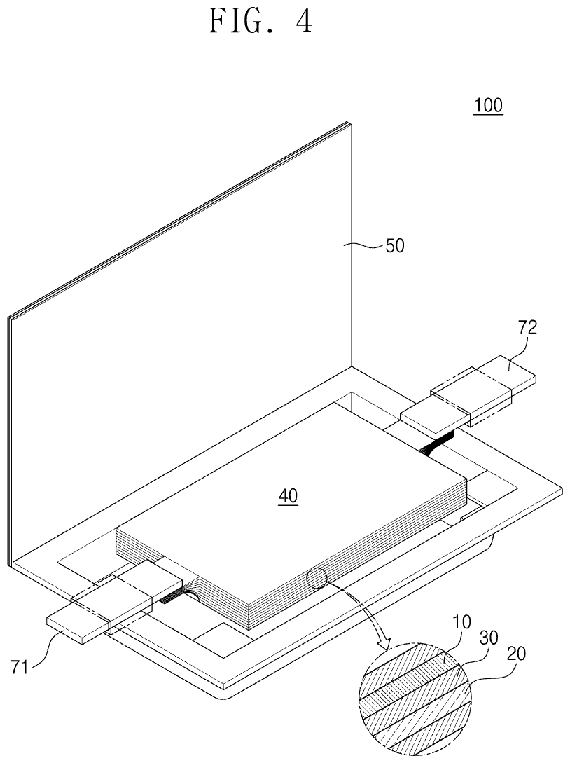

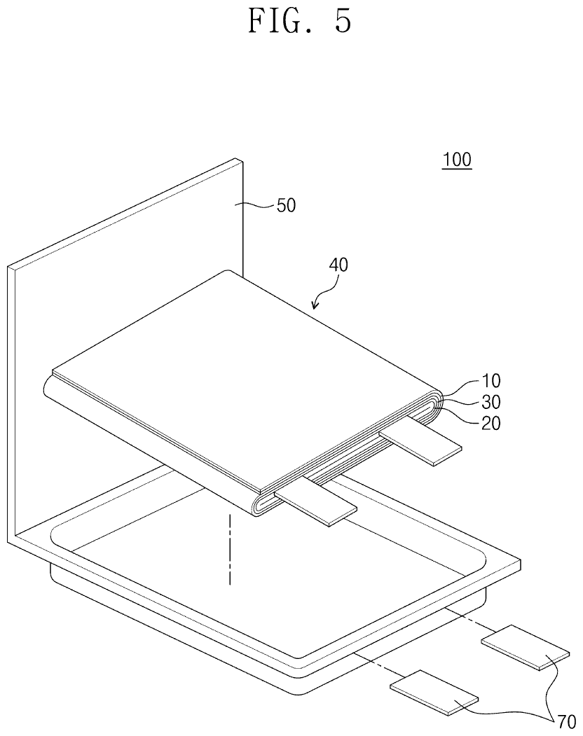

Based on shape of a rechargeable lithium battery, the rechargeable lithium battery may be classified into cylindrical, prismatic, pouch, and coin types (or kinds). FIGS. 2-5 are simplified views showing rechargeable lithium batteries according to embodiments. FIG. 2 shows a cylindrical battery, FIG. 3 shows a prismatic battery, and FIGS. 4-5 show pouch-type batteries. Referring to FIGS. 2-4, a rechargeable lithium battery 100 may include an electrode assembly 40 in which a separator 30 is between a positive electrode 10 and a negative electrode 20, and may also include a casing 50 in which the electrode assembly 40 is accommodated. The positive electrode 10, the negative electrode 20, and the separator 30 may be impregnated with an electrolyte. The rechargeable lithium battery 100 may include a sealing member 60 that seals the casing 50 as illustrated in FIG. 2. In embodiments, as illustrated in FIG. 3, the rechargeable lithium battery 100 may include a positive lead tab 11, a positive terminal 12, a negative lead tab 21, and a negative terminal 22. As shown in FIGS. 4-5, the rechargeable lithium battery 100 may include an electrode tab 70 (FIG. 5), or a positive electrode tab 71 and a negative electrode tab 72 (FIG. 4), which serves as an electrical path for externally inducing a current generated in the electrode assembly 40.

The following will describe in more detail an electrolyte for a rechargeable lithium battery according to some embodiments of the present disclosure.

According to an embodiment, an electrolyte for a rechargeable lithium battery may include a non-aqueous organic solvent, a lithium salt, a first additive including a borate-based lithium salt having a double bond between carbon atoms, and a second additive including a disultone-based compound.

The non-aqueous organic solvent may be a mixed solvent of ethylene carbonate (EC), ethylmethyl carbonate (EMC), and dimethyl carbonate (DMC).

For example, the ethylene carbonate (EC) solvent may be included at about 10 vol % to about 30 vol % based on the total volume of the non-aqueous organic solvent. The ethylmethyl carbonate (EMC) solvent may be included at about 40 vol % to about 50 vol % based on the total volume of the non-aqueous organic solvent. The dimethyl carbonate (DMC) solvent may be included at about 40 vol % to about 70 vol % based on the total volume of the non-aqueous organic solvent. In embodiments, a rechargeable lithium battery may improve in high-voltage and/or high-temperature properties.

The lithium salt may include, for example, LiPF6.

The lithium salt may have a concentration of about 0.1 M to about 2.0 M. For example, the lithium salt may have a concentration of equal to or greater than about 0.5 M or about 1.0 M. The lithium salt may have a concentration of equal to or less than about 2.0 M, equal to or less than about 1.7 M, or equal to or less than about 1.5 M. In embodiments the present disclosure, if the lithium salt has a concentration of about 0.1 M to about 2.0 M, the electrolyte may suitably or pertinently maintain its conductivity and viscosity.

### Additive

The first additive may be represented by Chemical Formula 1 below:

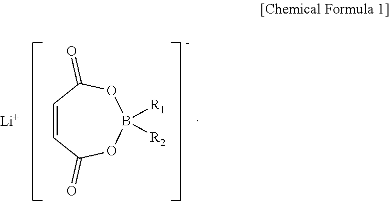

In Chemical Formula 1, R₁ and R₂ may include the same or different halogen elements. The halogen element may include fluorine, bromine, chlorine, iodine, or the like.

For example, the first additive may be represented by Chemical Formal 1-1 below:

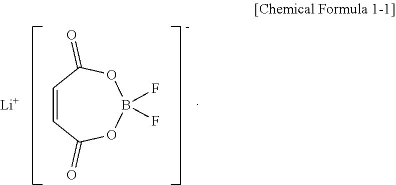

As the first additive has a structure having a double bond between carbon atoms, compared to a lithium salt additive having an ordinary ester bond, the first additive may have an effect of reducing the gas generation by suppressing or reducing a radical decomposition reaction and may increase both high-temperature performance and output properties.

In embodiments, as the first additive has a halogen component such as fluorine, LiF generated during charge/discharge procedures may form a strong film on both the positive and negative electrodes. Thus, the first additive may effectively contribute to cycle lifetime characteristics of a lithium battery.

The second additive may be represented by Chemical Formula 2 below:

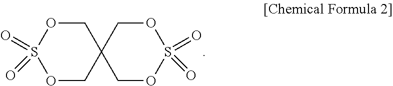 [SMILES: O=S1(=O)OCC2(CO1)COS(=O)(=O)OC2 ; "."]

If the second additive is used in combination with a fluorinated lithium salt additive (e.g., the first additive), a synergistic effect may be produced. The combination of the first additive and the second additive may cause a suppression or reduction of gas generation, an increase in high-temperature storage performance, and an improvement in high-temperature and room-temperature cycle stability of a lithium battery.

The first additive may be included at about 0.05 wt % to about 1 wt % based on the total weight of the electrolyte. For example, the first additive may be present in an amount of about 0.1 wt % to about 0.7 wt % based on the total weight of the electrolyte. The first additive may be present in an amount of about 0.2 wt % to about 0.5 wt % based on the total weight of the electrolyte. If the first additive has the aforementioned concentrations in the electrolyte, a protective film having suitable or proper film resistance may be formed on a surface of a positive electrode in a lithium battery, thereby improving cycle properties of the lithium battery and reducing the gas generation at high-temperature storage.

The second additive may be included at about 0.05 wt % to about 3 wt % based on the total weight of the electrolyte. For example, the second additive may be present in an amount of about 0.1 wt % to about 2 wt % based on the total weight of the electrolyte. The second additive may be present in an amount of about 0.5 wt % to about 1 wt % based on the total weight of the electrolyte. If the second additive has the aforementioned concentrations in the electrolyte, it may be possible to prevent or reduce an increase in battery inner resistance. In embodiments, the second additive may improve high-temperature battery performance.

In an embodiment of the present disclosure, the second additive may have a concentration (or weight ratio) greater than that of the first additive. A ratio of the concentration of the second additive to the concentration of the first additive may be in a range from about 1.5 to about 10. For example, the ratio of the concentration of the second additive to the concentration of the first additive may be in a range from about 2 to about 5.

In an embodiment, a rechargeable lithium battery may be provided which includes a positive electrode including a positive electrode active material, a negative electrode including a negative electrode active material, and an electrolyte discussed above.

A rechargeable lithium battery according to an embodiment of the present disclosure may use nickel-cobalt-aluminum based oxide as a positive electrode active material. In embodiments, the battery may significantly improve in high-voltage and/or high-temperature properties.

A rechargeable lithium battery according to an embodiment of the present disclosure may be applied to automotive vehicles, mobile phones, and/or any other electrical devices, but the present disclosure is not limited thereto.

The following will describe Examples and Comparative Examples of the present disclosure. The following Examples, however, are merely examples, and the present disclosure is not limited to the following Examples.

### EXAMPLES AND COMPARATIVE EXAMPLES

### Example 1

### (1) Fabrication of Electrolyte

LiPF₆ of about 1.25 M was dissolved in a non-aqueous organic solvent in which ethylene carbonate (EC), ethylmethyl carbonate (EMC), and dimethyl carbonate (DMC) were mixed together in a volume ratio of about 20:30:50, and a first additive of about 0.2 wt % and a second additive of about 0.5 wt % were added to fabricate an electrolyte.

A material represented by Chemical Formula 1-1 below was used as the first additive:

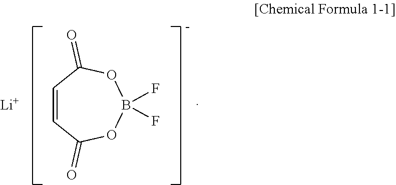

For example, the first additive of Chemical Formula 1-1 may be fabricated by the following reaction.

A compound of Chemical Formula 1-1 may be synthesized by a reaction route of Equation 1 below.

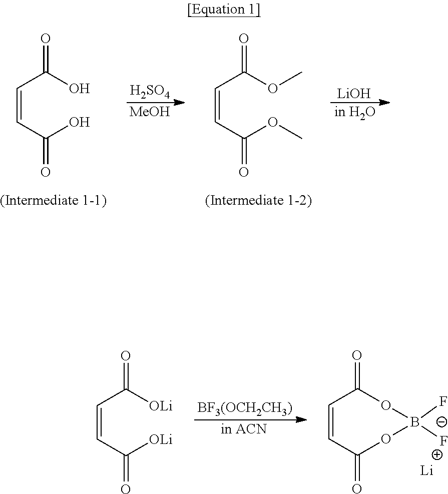

First, 1 mmol of maleic acid and 0.1 M sulfuric acid were added dropwise to a Schlenk flask in which methanol of 100 ml was present, and the mixture was stirred for 30 minutes at a temperature of 0° C. and then stirred for 24 hours at room temperature.

Afterwards, the mixture was extracted with MC/H₂O and a solvent was removed to obtain Intermediate 1-1.

Intermediate 1-1 of 1 mmol and lithium hydroxide of 2.5 mmol were added dropwise to a Schlenk flask in which H₂O of 100 ml was present, and the mixture was stirred for 1 hour at a temperature of 80° C. A compound obtained by filtering reaction precipitates was washed with acetone to obtain Intermediate 1-2.

Intermediate 1-2 of 1 mmol and boron trifluoride diethyl etherate of 2.1 mmol were added dropwise to a Schlenk flask in which acetonitrile of 100 ml was present, and the mixture was stirred overnight (for 12 hours to 16 hours) at room temperature.

Thereafter, a compound obtained by filtering reaction precipitates was purified by re-precipitation in a small amount of dimethyl carbonate, and dried under vacuum to obtain a compound represented by Chemical Formula 1-1.

A material represented by Chemical Formula 2 below was used as the second additive:

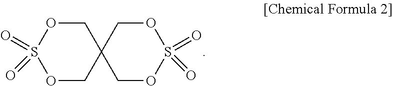 [SMILES: O=S1(=O)OCC2(CO1)COS(=O)(=O)OC2 ; "."]

### (2) Fabrication of Rechargeable Lithium Battery

LiNiCoAlO₂ (NCA) as a positive electrode active material, polyvinylidene fluoride as a binder, and acetylene black as a conductive material were mixed together in a weight ratio of 96:3:1, and the mixture was distributed in N-methyl pyrrolidone to fabricate a positive electrode active material slurry.

The positive electrode active material slurry was coated on an Al foil of 15 μm in thickness, dried at a temperature of 100° C., and then pressed to fabricate a positive electrode.

A silicon negative electrode active material, a styrene-butadiene rubber binder, and carboxymethyl cellulose were mixed together in a weight ratio of 98:1:1, and dispersed in distilled water to fabricate a negative electrode active material slurry.

The negative electrode active material slurry was coated on a Cu foil of 10 μm in thickness, dried at a temperature of 100° C., and then pressed to fabricate a negative electrode.

The positive electrode, the negative electrode, and a 10 μm-thick polyethylene separator were assembled to fabricate an electrode assembly, and the electrolyte was introduced to fabricate a rechargeable lithium battery.

### Example 2

An electrolyte and a rechargeable lithium battery were fabricated by the same method as that of Example 1, except that the second additive of 1.0 wt % was used.

### Example 3

An electrolyte and a rechargeable lithium battery were fabricated by the same method as that of Example 1, except that the first additive of 0.5 wt % and the second additive of 1.0 wt % were used.

### Comparative Example 1

An electrolyte and a rechargeable lithium battery were fabricated by the same method as that of Example 1, except that neither the first additive nor the second additive was added when the electrolyte was fabricated.

### Comparative Example 2

An electrolyte and a rechargeable lithium battery were fabricated by the same method as that of Example 1, except that lithium bis(oxalate)borate (LiBOB) of 0.2 wt % was used instead of the first additive if the electrolyte was fabricated.

The LiBOB may be represented by Chemical Formula 3 below:

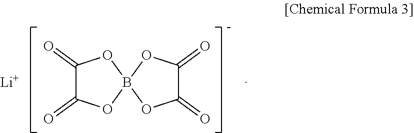

### Comparative Example 3

An electrolyte and a rechargeable lithium battery were fabricated by the same method as that of Example 2, except that LiBOB of 0.5 wt % was used instead of the first additive when the electrolyte was fabricated.

### Comparative Example 4

An electrolyte and a rechargeable lithium battery were fabricated by the same method as that of Example 3, except that propylene sulfite (PS) of 1 wt % was used instead of the second additive when the electrolyte was fabricated.

The PS may be represented by Chemical Formula 4 below:

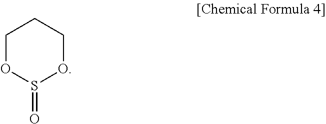

### Evaluation Example

A rechargeable lithium battery was evaluated by the following method.

### Evaluation 1: Evaluation of Storage at High Temperature (60° C.)

After a fabricated cell battery was charged to 4.2 V at a 1 C charge rate and then discharged to SOC50, the fabricated cell battery was discharged for 10 seconds at each of four C-rates to measure an initial direct-current internal resistance (DC-IR) and stored for 60 days at a high temperature (60° C.) after being charged to 4.2 V at a 1 C charge rate, and then identically to the initial direct-current internal resistance measurement method, a procedure of 1 C charge to 4.2 V and 1 C discharge was performed twice to measure a direct-current internal resistance (DC-IR) after being stored at a high temperature (60° C.) and evaluated results were listed in Table 1 below.

TABLE 1

| | | DC-IR after high- | DC-IR |
|---|---|---|---|
| | Initial DC-IR | temperature storage | increase |
| | Remaining | (60° C., 60 days) | rate |
| | capacity (mΩ) | Recovery capacity (mΩ) | (%) |
| Example 1 | 8.94 | 10.76 | 120.4 |
| Example 2 | 8.98 | 10.76 | 119.8 |
| Example 3 | 9.18 | 10.47 | 114 |
| Comparative | 8.49 | 10.74 | 126.5 |
| Example 1 | | | |
| Comparative | 8.85 | 10.68 | 120.7 |
| Example 2 | | | |
| Comparative | 8.91 | 10.47 | 117.5 |
| Example 3 | | | |
| Comparative | 8.96 | 10.84 | 120.9 |
| Example 4 | | | |

### Evaluation 2: Evaluation of Gas Generation at High Temperature

The rechargeable lithium battery according to the Examples and Comparative Examples underwent evaluation of gas generation characteristics at high temperature. The rechargeable lithium battery according to the Examples and Comparative Examples was stored for 28 days at 60° C.

To ascertain a gas reduction effect, an initial thickness of the cell battery and a thickness of the cell battery after 28-day storage were each measured, and results were listed in Table 2 below. For example, a press-type thickness gauge commercially available from MITUTOYO Corporation was used such that a pouch cell was between press plates and then a thickness was measured while being pressed with a weight of 300 g. In Table 2 below, an initial thickness section shows thicknesses measured immediately after being released from an oven at 60° C. so as to exclude a cooling effect, and the same method was executed to measure thicknesses after being stored for 28 days in a thermostat at 60° C.

TABLE 2

Cell thickness change according to
high-temperature storage (60° C.) (cm)

| | Initial | After 28 days |
|---|---|---|
| Embodiment 1 | 10.34 | 14.68 |
| Embodiment 2 | 10.33 | 14.59 |
| Embodiment 3 | 10.36 | 14.37 |
| Comparative 1 | 10.36 | 15.05 |
| Comparative 2 | 10.34 | 15.31 |
| Comparative 3 | 10.35 | 15.64 |
| Comparative 4 | 10.34 | 14.51 |

### Comprehensive Evaluation

Referring to Table 1, use of an electrolyte to which are added the first additive and the second additive according to embodiments of the present disclosure (Examples 1 to 3), it may be possible to ascertain an improvement in DC-IR according to high-temperature storage (60° C.) compared to use of an electrolyte to which no additive is added (Comparative Example 1) and to use of an electrolyte to which is not added a combination of a borate-based lithium salt having a double bond between carbon atoms and a disultone-based compound (Comparative Examples 2 to 4). Therefore, if an electrolyte is added with a combination of the first additive and the second additive according to the present disclosure, it may be ascertained that there is an improvement in cycle properties and lifetime efficiency of a battery at an environment of high-temperature storage (60° C.).

Referring to Table 2, in use of an electrolyte to which are added the first additive and the second additive according to embodiments of the present disclosure (Examples 1 to 3), it may be possible to ascertain an improvement in cell thickness change according to high-temperature storage (60° C.) compared to use of an electrolyte to which no additive is added (Comparative Example 1) and to use of an electrolyte to which is not added a combination of a borate-based lithium salt having a double bond between carbon atoms and a disultone-based compound (Comparative Examples 2 to 4). Therefore, in a rechargeable lithium battery that uses compounds represented by Chemical Formulae 1 and 2 in accordance with embodiments of the present disclosure, it may be ascertained that the gas generation at a high temperature (60° C.) is effectively suppressed compared to Comparative Examples 1 to 4.

In an electrolyte according to an embodiment, a borate-based lithium salt having a double bond between carbon atoms and a disultone-based compound may be used as an additive to prevent or reduce the generation of a large amount of gas at high-temperature conditions if a rechargeable lithium battery is activated. Moreover, an electrolyte according to embodiments of the present disclosure may have an effect of causing an improvement in high-temperature storage and high-temperature lifetime properties of a rechargeable lithium battery.

While the subject matter of this disclosure has been described in connection with what is presently considered to be practical example embodiments, it is to be understood that the present disclosure is not limited to the disclosed embodiments and is intended to cover various modifications and equivalent arrangements included within the spirit and scope of the appended claims and equivalents thereof, and therefore the aforementioned embodiments should be understood to be examples but not limiting this disclosure in any way.

What is claimed is:

1. An electrolyte for a rechargeable lithium battery, the electrolyte comprising:
a non-aqueous organic solvent;
a lithium salt;
a first additive that comprises a borate-based lithium salt having a double bond between carbon atoms; and
a second additive that comprises a disultone-based compound.

2. The electrolyte as claimed in claim 1, wherein the first additive is represented by Chemical Formula 1, 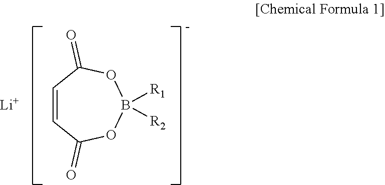
wherein in Chemical Formula 1, R₁ and R₂ comprise the same or different halogen elements.

3. The electrolyte as claimed in claim 1, wherein the first additive is represented by Chemical Formula 1-1,

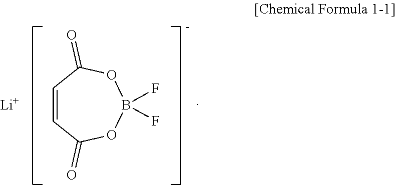

4. The electrolyte as claimed in claim 1, wherein the first additive is included in an amount of 0.05 wt % to 1 wt % based on a total weight of the electrolyte.

5. The electrolyte as claimed in claim 1, wherein the second additive is represented by Chemical Formula 2,

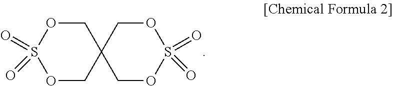 [SMILES: O=S1(=O)OCC2(CO1)COS(=O)(=O)OC2 ; "."]

6. The electrolyte as claimed in claim 1, wherein the second additive is included in an amount of 0.05 wt % to 3 wt % based on a total weight of the electrolyte.

7. The electrolyte as claimed in claim 1, wherein the non-aqueous organic solvent comprises a carbonate-based solvent,
wherein the carbonate-based solvent comprises one or more selected from ethylene carbonate (EC), ethylmethyl carbonate (EMC), dimethyl carbonate (DMC), diethyl carbonate (DEC), dipropyl carbonate (DPC), methylpropyl carbonate (MPC), ethylpropyl carbonate (EPC), methylethyl carbonate (MEC), propylene carbonate (PC), and butylene carbonate (BC).

8. The electrolyte as claimed in claim 1, wherein the lithium salt comprises one or more selected from LiPF₆, LiBF₄, LiSbF₆, LiAsF₆, LiClO₄, LiAlO₂, LiAlCl₄, LiPO₂F₂, LiCl, LiI, LiN(SO₃C₂F₅)₂, Li(FSO₂)₂N, lithium bis(fluorosulfonyl)imide (LiFSI), and LiC₄F₉SO₃.

9. The electrolyte as claimed in claim 1, wherein a concentration of the lithium salt is in a range of 0.1 M to 2.0 M.

10. A rechargeable lithium battery, comprising:
a positive electrode that comprises a positive electrode active material;
a negative electrode that comprises a negative electrode active material; and
the electrolyte as claimed in claim 1.

11. The rechargeable lithium battery as claimed in claim 10, wherein the positive electrode active material comprises a nickel-cobalt-aluminum (NCA)-based lithium composite oxide.

12. The rechargeable lithium battery as claimed in claim 10, wherein the negative electrode active material comprises a carbon-based negative electrode active material, a silicon-based negative electrode active material, or a combination thereof.
